(19) United States
(12) Patent Application Publication
(10) Pub. No.: US 2007/0008860 A1
(43) Pub. Date: Jan. 11, 2007

(54) Optical data reading/writing device having separated read and write beams

(75) Inventors: Coen Theodorus Hubertus Fransiscus Liedenbaum, Eindhoven (NL); Bernardus Hendrikus Wilhelmus Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/571,875

(22) PCT Filed: Oct. 7, 2004
(86) PCT No.: PCT/IB04/52015

§ 371 Date: Apr. 5, 2006

(30) Foreign Application Priority Data
Oct. 15, 2003 (EP) 031038037

(51) Int. Cl. G11B 7/135

(52) U.S. Cl. 369/112.29

(57) ABSTRACT

A method is proposed that allows a static design of an optical pickup unit (OPU) that delivers two output beams (30, 32). Both laser beams (30, 32) result in successive spots, which have the appropriate characteristics. In this OPU concept both read and write spots are present at the same time, and they are sufficiently spaced apart in the focus direction. This allows switching from the read situation to the write situation by introducing an appropriate focus offset in the electronics. The two output beams (30,32) are generated from a polarized incoming beam, said polarized incoming beam is split by a tilted birefringent grating (18).

This invention relates to an optical data reading/writing device having twin reading and writing beams and to a method producing read and write beams simultaneously in an optical reading/writing device.

The pace at which the progress in optical recording systems moves is mainly dominated by the available optical power from semiconductor lasers. In designing optical pick-up units (OPUs), one faces a big dilemma. The optical output beam of state of the art semiconductor lasers (most specifically for blue lasers) is not circular, but is characterised by a large asymmetry in the beam divergence up to values of 1:3. The optical spot on the disc ideally should be circularly shaped, implying that one has to convert the asymmetric input laser beam into a circular one (using beam-shaping for example) or one overfills an entrance pupil of an objective lens, in order to get a reasonable spot on the disc. Both approaches (beam-shaping and overfill) are being applied in current OPUs, but either at the expense of introducing extra cost in the OPU by adding components or at the cost of losing precious laser power. As a reference the total transmission of a blue optical pickup suitable for reliably reading out Blu-ray disk data is typically only 15%.

There is, however, a subtle difference between the need for the perfect spot in the read situation or the write situation. In the standard for Blu-ray disk it has been defined that the RIM intensity has to be 65% in both tangential and radial directions. In the write situation it has been shown experimentally that a lower RIM intensity may be allowed, down to a value of 40%, while one is still capable of writing data reliably to the disk. The resulting transmission of the light path goes to 30% or an increase of a factor two.

This difference allows therefore an OPU to be devised that has a high transmission in combination with a somewhat deteriorated spot for the write situation and a relatively low transmission in combination with a high quality spot in the read situation.

The methods proposed thus far are based on devices that switch between one state and the other state. Although these proposed methods lead to higher beam efficiency for the writing mode while having high rim intensity in the reading mode, they require additional switchable devices making these solutions rather costly. Another effect is that most of these devices introduce some light losses.

It is an object of the present invention to address the abovementioned disadvantages.

It is a further object of the present invention to achieve a high incouple efficiency in an optical reading/writing device for the writing mode and a high rim intensity for the reading mode without costly switchable devices.

According to a first aspect of the invention an optical reading/writing device for reading/writing to an information layer comprises a radiation source for generating a radiation beam and an objective system for converging the radiation beam on the information layer, wherein the objective system includes a beam splitting element adapted to split the radiation beam into a read beam and a write beam.

The advantageous use of a beam splitting element allows a single radiation source to produce read and write beams simultaneously without a switching device, because the radiation beam is split into two beams.

Preferably, the objective system is adapted to converge the read beam and the write beam on separate locations, preferably locations spaced substantially along an optical axis of the objective system.

The separation of the spots is advantageous in having only one of the read and write beams focussed on the information layer at a given time. In view of the separation there are preferably two focus error signals from the read and write beams.

In view of the separate focussing of the read and write beams, the objective system is preferably arranged such that the write beam has insufficient intensity at the information layer to affect data on the information layer when the read beam is focussed on the information layer.

Advantageously, although the read and write beams both impinge on the information surface at the same time, the fact that only one is in focus results in the out of focus beam having no effect on the information layer.

The beam splitting element is preferably adapted to reshape the read beam.

Advantageously, the read beam is re-shaped to improve the read beam characteristics, preferably a rim intensity of the read beam, for a read operation.

Preferably, the objective system includes focus offset means adapted to focus one of the read beam or the write beam on the information layer. Preferably, the focus offset means are electronic focus offset means.

The advantageous use of electronic focus offset means provides benefits over a beam switching element, including reduced manufacture cost and greater simplicity.

The beam splitting element is preferably a diffraction grating element, more preferably a birefringent grating element.

Preferably, the beam splitting element has a substructure in which a contribution efficiency increases radially outwards.

The radial increase advantageously increases relative rim intensity for the beam.

The invention extends to an optical pickup device forming a part of the optical reading/writing device of the first aspect.

According to a second aspect of the invention a method of producing reading and writing beams in an optical reading/writing device comprises:

generating a radiation beam with a radiation source and converging the radiation beam on an information layer with an objection system, wherein the beam is split into a reading beam and a writing beam with a beam splitting element of the objective system.

The invention extends to a method of writing to an information layer with an optical reading/writing device as described in the first aspect.

The invention extends to a method of reading an information layer with an optical reading/writing device as described in the first aspect.

All of the features described herein may be combined with any of the above aspects, in any combination.

For a better understanding of the invention, and to show how embodiments of the same may be carried into effect, reference will now be made, by way of example, to the accompanying diagrammatic drawings in which:

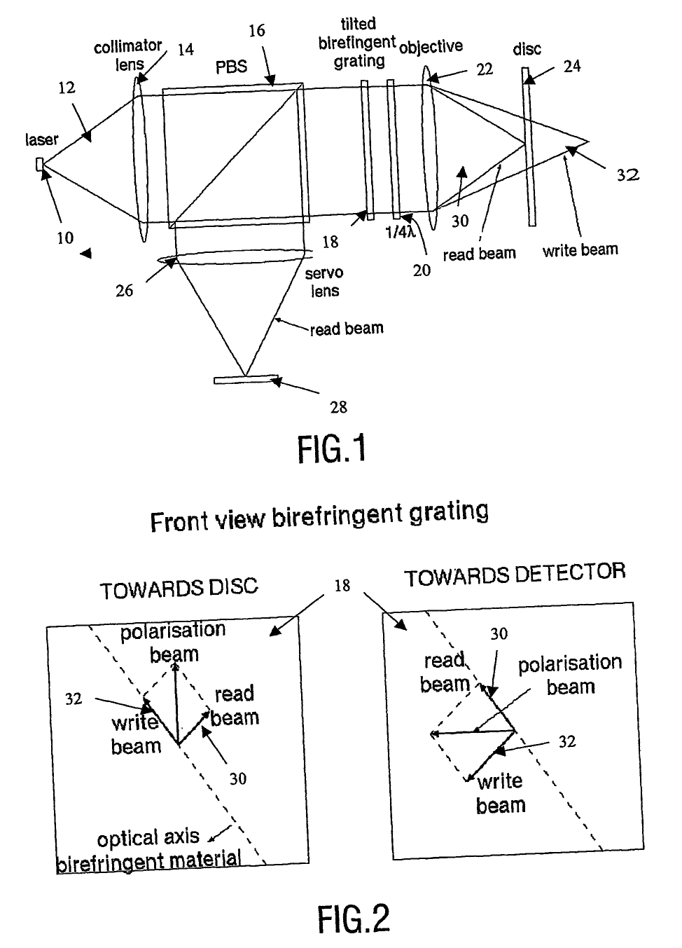

FIG. 1 is a schematic diagram of an optical pickup unit providing reading and writing beams simultaneously; and

FIG. 2 is a schematic diagram of front views towards a disc and towards a detector of a birefringent grating.

In the following a method is proposed that allows a static design of an optical pickup unit (OPU) that delivers two output beams. Both laser beams result in successive spots, which have the appropriate characteristics. In this OPU concept both read and write spots are present at the same time, and they are sufficiently spaced apart in the focus direction. As a result, when one of the two output beams is in focus with the information layer of the disc the other beam does not significantly influence the marks of the information layer. When the objective lens is moved along the optical axis in order to bring the output beam into focus, two distinct focus error signals can be detected. Using this focus error signal it is possible to bring one of the beams into focus with the information layer. This allows switching from the read situation to the write situation by positioning the appropriate spot on the information layer disc surface.

The basic idea is thus to start with a beam which is optimal from the point of view of the writing mode, hence we have high incouple efficiency and low rim intensity lets say by example only 40% rim intensity. Since we have enough power in this configuration part of the power may be diverted to a separate read beam. The remaining write beam is not affected by the components in the light path on its way to the information layer of the disc. The read beam part however will be reshaped to a beam that still has enough power for reading but with increased rim intensity.

In table 1 some properties for the reading and writing mode are given. For writing the maximum available power from the laser is 60 mW pulsed. For dual layer 10 mW pulsed on the disc is required. For a conventional light path having 40% rim intensity the light path efficiency is typically 30%. This means that only ˜60% of the maximum power of the laser is needed in this mode. As a result if we split off ˜40% of the power of the laser for the reading case we have available 12 mW cw (40% of 30 mW cw) laser power for reading mode. The required power on the disc is 0.8 mW cw. Since this beam travels through the same light path as for the writing mode the light path efficiency (without beam intensity reshaping component) is the same as for the writing mode, hence 30%. From this it follows that the beam reshaping component requires only an efficiency of ˜25% in order to have sufficient power on the disc for the reading case. As stated before the reshaping component may only affect the reading beam and not the writing beam.

TABLE 1

| | | | | Corresponding |
|---|---|---|---|---|
| | | Required | | light path |
| | | power on | | efficiency |
| | | disc (dual | Rim | conventional |
| Mode | Max laser power | layer) | intensity | light path |
| writing | 60 mW pulsed | 10 mW pulsed | 40% | 30% |
| reading | 30 mW cw | 0.8 mW cw | 65% | 15% |

### Light Path Embodiment

An example of a light path for the double beam solution is shown in FIG. 1.

A laser 10 emits a radiation beam 12 to a collimator lens 14 which passes through a polarising beam splitter (PBS) 16 to a tilted birefringent grating 18 and a 1/4 w plate 20. The birefringent grating 18 splits the beam 12 into a read beam 30 and a write beam 32. An objective lens 22 then focuses the read beam 30 on a disc 24. The read beam 30 is then reflected back to the PBS 16 and on to a servo lens 26 and a detector 28. It can be seen that a write beam 32 is focussed beyond the disc 24.

Two beams 30, 32 are generated by the tilted birefringent grating 18. The incoming polarisation of the beam 12 makes an angle with an optical axis of the grating 18 (see FIG. 2). The write beam 32 is unaffected by the grating 18 on the way towards the disc 24, while the read beam 30 is diffracted and reshaped. The read 30 and the write 32 beams focus therefore on different z positions. When the read beam 30 is in focus with an information layer of the disc 24, the reflected beam is in focus on the detector 28 too, while the write beam 32 is both out of focus on the disc 24 and detector 28. When we focus the write beam 32 on the disc 24 the situation is reversed.

As a beam splitting and read beam reshaping element 18 we propose to use a birefringent grating of a binary type (see for instance WO0249024 (=PHNL000683), the contents of which are incorporated herein by reference) (see FIG. 1 and 2 ). The optical axis of the birefringent material is along the Z-axis (propagation axis). It is aligned such that its refractive index equals ne when the traversing beam has polarisation along the X-axis and no when the beam has polarisation along the Y-axis. We consider now the case where the polarisation of the laser beam makes an angle with the X-axis, such that 60% of the beam sees the no refractive index (write beam) and 40% of the beam sees the ne refractive index (read beam). Let the binary steps making up the grating be such that the binary steps have heights equal to

$$h = \frac{λ}{no - 1}$$

As a result for the write beam 32 the grating 18 gives rise only to phase steps equal to a multiple of 27 and hence only zero order diffraction is selected. For the read beam 30 however the steps are no longer equal to a multiple of 2π and hence also nonzero diffraction orders are selected. With proper design of the steps it is possible to select with high efficiency a preferred diffraction order. This selection together with designing the pitch of the grating 18 makes it possible to let the read beam 30 and the write beam 32 focus on different positions after passing the objective lens 22 (see for instance WO0249024 mentioned above).

The last step is to reshape the intensity distribution of the reading beam 30. To do this without affecting the writing beam 32 can be done as follows. The transmission to the selected diffraction order for the reading beam 30 of the grating 18 must increase as a function of the radial direction of the beam 30. A conventional grating consists of various annular zones, where each zone has the same substructure. This substructure defines how much efficiency each zone contributes to a particular diffraction order. For the conventional grating this substructure is the same for all zones and therefore each zone contributes the same fraction to the particular order. However, making the substructure different for each zone, the contribution to the particular diffraction order for each zone becomes different. When we let the contribution efficiency of the zone increase in the radial direction the central part of the diffracted beam becomes reduced in intensity compared to the rim intensity, and as a result the relative rim intensity increases.

Consider a Gaussian beam having 40% rim intensity. This beam can be written as

$$I ( r ) = {I}_{0} exp [ - {( \frac{r}{1.045} )}^{2} ]$$

Where Io is the intensity at the centre of the light beam and r is the normalised entrance pupil radius (r=1 is at the rim of the entrance pupil).

To transform this into a beam having a rim intensity of 65%, the central part of the above beam must be reduced in intensity to 61.5% of its original intensity.
The reshaped beam can then be written as

$${I}_{shaped} ( r ) = 0.615 {I}_{0} exp [ - {( \frac{r}{1.524} )}^{2} ]$$

The total intensity of the reshaped beam is 25% lower than that of the original beam. The reshaping can be obtained with 75% transmission efficiency. This is higher than the minimum requirement (25% transmission efficiency). As a result the requirement of 0.8 mW cw on the disc, 30% light path efficiency and 75% reshaping efficiency means that we need 3.6 mW cw laser power (12% of total laser power (see table 2)). In fact this means that we may reserve more than the 60% laser power for the writing beam 32.

TABLE 2

| Mode | Write | read |
|---|---|---|
| Light path efficiency without reshaping | 30% | 30% |
| component | | |
| Reshaping element efficiency | 100% | 75% |
| Total light path efficiency | 30% | 22.5% |
| Required maximum power on disc | 10 mW pulsed | 0.8 mW cw |
| Maximum laser power | 60 mW pulsed | 30 mW cw |
| Required fraction of maximum | 56% | 12% |
| laser power | | |

From table 2 it follows that when putting the laser 10 at 70% of the maximum power and splitting the beam for 21% in a read beam 30 according to the above invention and for 79% in a write beam 32, reading and writing is possible. As a result there is 30% of the laser power left which can be used either for reading/writing disc at higher speeds or allow for lasers in the light path having a lower maximum output power (hence which are cheaper).

As shown in FIG. 2, in the view towards the disc the write beam 32 is unaffected by the birefringent grating 18, but when reflected from the disc 24 the polarisation has become perpendicular to that of the incoming beam (due to ¼λ plate) and the write beam 32 becomes now affected. For the read beam 30 the opposite is true. The influence of the write beam on the way back to the detector is allowed, because the spot on the detector need not to be diffraction limited.

The invention can be used in a recording optical pick up, such as for a Blu-ray Disc.

1. An optical reading/writing device for reading/writing to an information layer comprises a radiation source for generating a radiation beam and an objective system for converging the radiation beam on the information layer, wherein the objective system includes a beam splitting element adapted to split the radiation beam into a read beam and a write beam.

2. An optical reading/writing device as claimed in claim 1, in which the objective system is adapted to converge the read beam and the write beam on separate locations.

3. An optical reading/writing device as claimed in claim 1, in which the objective system is arranged such that the write beam has insufficient intensity at the information layer to affect data on the information layer when the read beam is focussed on the information layer.

4. An optical reading/writing device as claimed in claim 1, in which, in use, the read and write beams produce two focus error signals.

5. An optical reading/writing device as claimed in claim 1, in which the beam splitting element is adapted to reshape the read beam.

6. An optical reading/writing device as claimed in claim 1, in which the read beam is re-shaped to improve a rim intensity of the read beam.

7. An optical reading/writing device as claimed in claim 1, in which the objective system includes electronic focus offset means adapted to focus one of the read beam or the write beam on the information layer.

8. An optical reading/writing device as claimed in claim 1, in which the beam splitting element is a birefringent grating element.

9. An optical reading/writing device as claimed in claim 7, in which the beam splitting element has a substructure in which a contribution efficiency increases radially outwards.

10. An optical reading/writing device as claimed in claim 9, in which the radial increase increases relative rim intensity for the beam.

11. An optical pickup device forming a part of an optical reading/writing device of claim 1.

12. A method of producing reading and writing beams in an optical reading/writing device comprises:
generating a radiation beam with a radiation source and converging the radiation beam on an information layer with an objection system, wherein
the beam is split into a reading beam and a writing beam with a beam splitting element of the objective system.

13. A method of writing to an information layer with an optical reading/writing device as claimed in claim 1.

14. A method of reading an information layer with an optical reading/writing device as claimed in claim 1.
